(19) United States
(12) Patent Application Publication
(10) Pub. No.: US 2026/0257773 A1
(43) Pub. Date: Sep. 3, 2026

(54) CONNECTING ASSEMBLY

(71) Applicant: UNLCKED UG, Hamburg (DE)

(72) Inventor: Klaas Gunnar HÖPCKE, Hamburg (DE)

(73) Assignee: UNLCKED UG, Hamburg (DE)

(21) Appl. No.: 19/162,802

(22) PCT Filed: Mar. 5, 2024
(86) PCT No.: PCT/EP2024/055686

§ 371 Date: Sep. 5, 2025

(30) Foreign Application Priority Data
Mar. 7, 2023 (EP) 23160567.6

(51) Int. Cl. B63B 32/73; F16G 11/03

(52) U.S. Cl. CPC B63B 32/73; F16G 11/03

(57) ABSTRACT

A connecting assembly for connecting an object to a leash, that comprises a first connector for attaching to the object, and a second connector for attaching the leash, which is connected to the first connector by a flexible connecting element such that they can move in relation to one another. The first connector has a bore through which the connecting element passes, and the connecting element is rotatably retained in the bore. The second connector has an accommodating space with a perforation for the leash leading into the accommodating area, which is large enough to accommodate the knot in the leash such that it can rotate therein.

### CROSS-REFERENCE TO RELATED APPLICATIONS

This application claims priority from European Patent application No. EP 23160567.6 filed Mar. 7, 2023 and international application PCT/EP2024/055686, filed Mar. 5, 2024, the disclosures of which are hereby incorporated herein in their entirety by reference.

### BACKGROUND OF THE INVENTION

### Field of the Invention

The present invention relates to a connecting assembly for attaching an object to a leash.

### Background

These connecting assemblies are needed for surfboards, for example, for attaching the leash to a wrist or ankle, by which means surfboards for windsurfing, kitesurfing and stand-up paddle boarding can be attached to the body. Of course, any element that has a leash can be attached to any type of object with this kind of connecting assembly, e.g. to a ring or pole in the water. This type of connecting assembly has first and second connectors that are connected to one another by a flexible connecting element. The first connector is attached to the object, e.g. the body or some other element such as a trapeze harness, and the second is connected to the leash attached to the surfboard. This type of connecting assembly is disclosed in U.S. Pat. No. 4,044,415 B. One of the disadvantages with this connecting assembly is that it has a complicated design that gets twisted up over time, such that it becomes worn and more difficult to use.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

The object of the invention is to therefore create a connecting assembly with which an object can be easily connected to a leash, that continues to function reliably despite frequent use and twisting of the two connectors in relation to one another.

This is achieved by a connecting assembly according to claim 1. Advantageous designs are the subject matter of the dependent claims. Advantageous embodiments of the invention are also described herein and shown the drawings.

This connecting assembly has a first connector for attaching it to the object and a second connector for attaching it to the leash, the two of which are connected to one another by a flexible connecting element such that they are spaced apart and can move in relation to one another to a certain extent. This connecting element can be a cord, line, cable, etc. The first connector has a bore through which the connecting element passes in which it can rotate. The second connector has a perforation in which the leash can rotate, with an accommodating section that is large enough for a knot in the leash.

The connecting assembly obtained with the invention thus allows the connecting element to rotate in the first connector and the leash to rotate in the second connector, such that even when the two parts are twisted frequently in relation to one another, the connecting element does not become twisted or knotted and the connecting assembly continues to function properly. The connecting element can be a cord or cable, allowing the two connectors to move freely in relation to one another.

In an advantageous further development of the invention, the first fastening part is elongated, and the bore runs parallel to its longitudinal axis, wherein the bore is widened at a first longitudinal end of the first fastening part to form a cylindrical receiving section with a diameter larger than that of the bore, and the receiving section is designed to rotatably receive a thickening fixed to the connecting element, for example a knot or the like. This ensures that the connecting element can rotate easily relative to the first fastening part.

In an advantageous further development of the invention, the first fastening part is elongated, and the bore runs parallel to its longitudinal axis, wherein the bore is widened at a first longitudinal end of the first fastening element to form a cylindrical receiving section with a diameter larger than that of the bore, and the receiving section is designed to rotatably receive a thickening fixed to the connecting element, for example a knot or the like. This ensures that the connecting element can rotate easily relative to the first fastening part.

In an advantageous design of the invention, at least an elongated section of the first connector is rotationally symmetrical, and a bore is formed in the rotational center of the rotationally symmetrical section. This ensures that forces are conducted into the middle of the first connector. One end of the first connector preferably has a plate-shaped extension, with the part for accommodating the connecting element formed in the center thereof. The plate-shaped end of the connector can thus be easily attached to the object, e.g. with a Velcro loop that can be placed on a wrist or ankle, or attached to a trapeze harness.

For this reason, the connecting assembly has a cuff, e.g. a Velcro strap for the wrist or ankle that is connected to the first connector, in particularly passing through it, such that the plate-shaped part bears on the inside of the cuff, securing the connecting element in the assembly to the object or person, even when the connecting element is pulled on. This plate-shaped end of the first connector bears on the inner surface of the cuff with its flat surface, such that it cannot be pulled out of the cuff at the point where the connector penetrates it.

In an advantageous embodiment of the invention, the first connector is cylindrical or conical over most of its length such that the connecting element can be securely retained and rotate therein, specifically in the center thereof.

This section is preferably rounded at the end where it transitions into the bore, such that there are no sharp edges that could damage the connecting element where it is knotted.

The second connector in an advantageous embodiment of the invention is a strap made of cloth or plastic that is folded together such that the ends meet, thus forming a loop with a perforation through which the leash passes to accommodate the knot on the end thereof. The knot is therefore contained inside the loop and cannot be pulled out of it, but can still rotate therein.

The connecting element preferably passes through the ends of the strap, thus holding the ends together to form the loop. This keeps the loop intact, because the more the connecting element is pulled on, the tighter these ends are pulled together.

One end has a Velcro strap in an advantageous design of the invention, that can be wrapped around the connecting element and the two ends of the strap to hold them together. This further improves the connection of the two ends of the strap. This also holds the connecting element in place in relation to the ends when it is being inserted through the perforation. It also protects this area against external effects.

In an alternative embodiment, the second connector is a molded component with a barrel-shaped or cylindrical section, the middle of which in the axial direction has the area for accommodating the knot on the end of the leash and a radial hole that opens into this area through which the leash is fed. This barrel-shaped or cylindrical section has circumferential grooves on both ends, and the connecting element has a loop at the end facing the second connector that is placed in the two grooves. Consequently, the second connector is held securely in place by the two grooves on its circumference, with the knot on the end of the leash in the space inside the barrel-shaped section, such that the leash can rotate readily therein. This molded part can preferably be made of plastic or rubber, such that it can be easily manipulated, is corrosion-resistant, and can be made with soft edges, such that it will not injure the user.

The second connector preferably has a radial insertion section for the connecting element on the side opposite the hole, through which the connecting element is inserted into the middle of the barrel-shaped section. Consequently, the connecting element is inserted radially into the middle of the barrel-shaped section, such that the loop on the end of the connecting element cannot be separated from the second connector, even when subjected to lateral tensions, potentially slipping out of these grooves.

It is clear to the person skilled in the art that the above exemplary embodiments can be combined arbitrarily with one another, as long as these combinations are not contradictory.

The term, “leash” is synonymous with a cord attached to a board.

### BRIEF DESCRIPTION OF THE DRAWING FIGURES

The invention shall be explained below in reference to the schematic drawings. Therein:

FIG. 1 shows a connecting assembly for an ankle cuff on a surfboard leash,

FIG. 2 shows a section II-II through the first connector in the connecting assembly in FIG. 1,

FIG. 3 shows a perspective view of the first connector with the ankle cuff shown in FIG. 1,

FIG. 4 shows a longitudinal section through the first connector, which has a plate-shaped end that fits into the ankle cuff,

FIG. 5 shows the second connector shown from the perspective V indicated in FIG. 1,

FIG. 6 shows a perspective view of the second connector in FIG. 1,

FIG. 7 shows a second exemplary embodiment of the connecting assembly, in which the first connector is connected to an ankle cuff, and the second connector is formed by a strap, the ends of which are held together to form a loop,

FIG. 8 shows the second connector shown from the side VIII indicated in FIG. 7,

FIG. 9 shows the second connector shown from the side IX indicated in FIG. 7,

FIG. 10 shows a side view of the second connector in FIG. 7, in which one end has a Velcro strap wrapped around the two ends and the connecting element.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

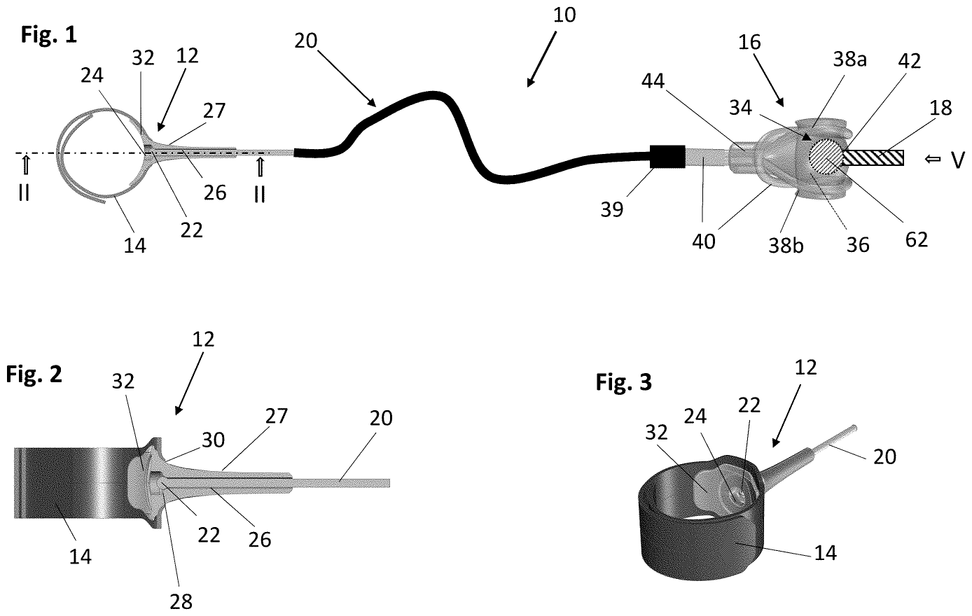

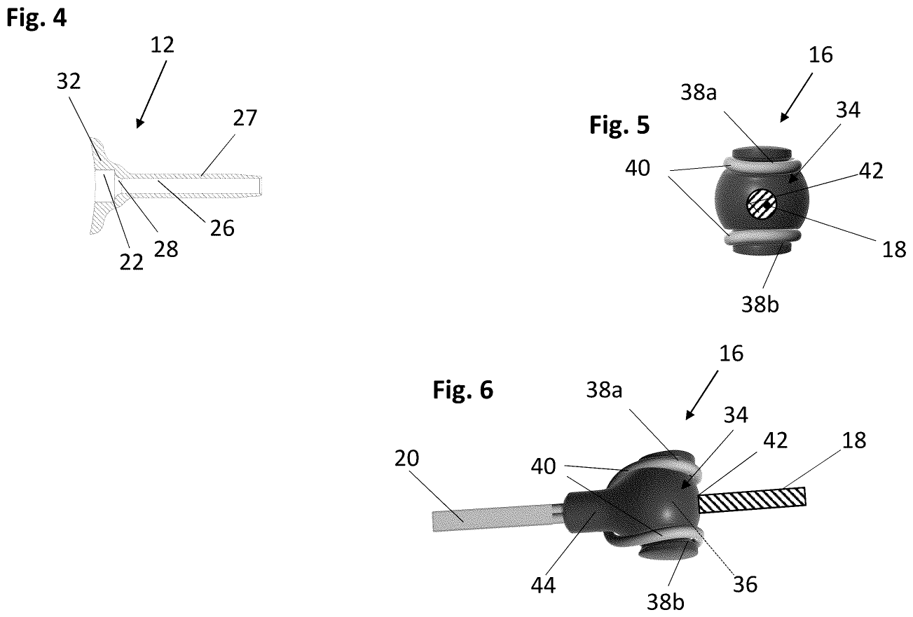

FIG. 1 shows a connecting assembly 10 comprising a first elongated connector 12 that engages with an ankle cuff 14, a second connector 16 for a leash 18, and an elongated connecting element 20 between the first and second connectors 12 and 16, which has a thickening 22 at one end that can be rotatably held in a cylindrical accommodating section 24, with the connecting element 20 being inserted through a bore 26 (see FIG. 4 in particular) in the first connector 12.

The cylindrical accommodating section 24 and the bore 26 are connected to one another by a round transition 28 formed between the bore 26 and the accommodating section 24 with no sharp edges that could potentially damage the connecting element 20, or its thickening 22 on its end. The connecting element 20 has a loop 40 at the end attached to the second connector 16 formed by bending back the free end of the connecting element 20 and attaching this end thereto with a splice 39. Most of the bore 26 in the first connector 12 is in a cylindrical or slightly conical elongated section 27 of the first connector.

FIGS. 2 and 3 clearly show how the first connector 12 passes through a perforation 30 in the ankle cuff, and how a plate-shaped end 32 of the first connector 12 bears on the inner surface of the foot loop (see FIG. 3 in particular). This secures the first connector 12 to the foot loop, and allows the connecting element 20 to rotate in the bore 26 and the accommodating section 24 through the interaction of the cylindrical accommodating section 24 and the thickening 22 on the end of the connecting element.

FIG. 1 clearly shows the second connector 16, which has a barrel-shaped section 34, the middle of which forms an accommodating area 36 for a knot on the end of the leash 18. Furthermore, there is a circumferential groove 38a, 38b on each end of the barrel-shaped section 34 of the second connector 16, into which the connecting loop 40 on the end of the connecting element 20 is placed, thus securing the second connector to the loop 40 in the connecting element 20. The middle of the barrel-shaped section 40 has a perforation 42 through which the leash 18 is inserted into the accommodating area 36. A radial insertion section 44 of the second connector 16 is formed opposite this perforation 42, through which the connecting element is inserted radially into the middle of the connector such that the connector 16 is securely retained in the loop 40 in the connecting element 20, even when subjected to lateral tensions.

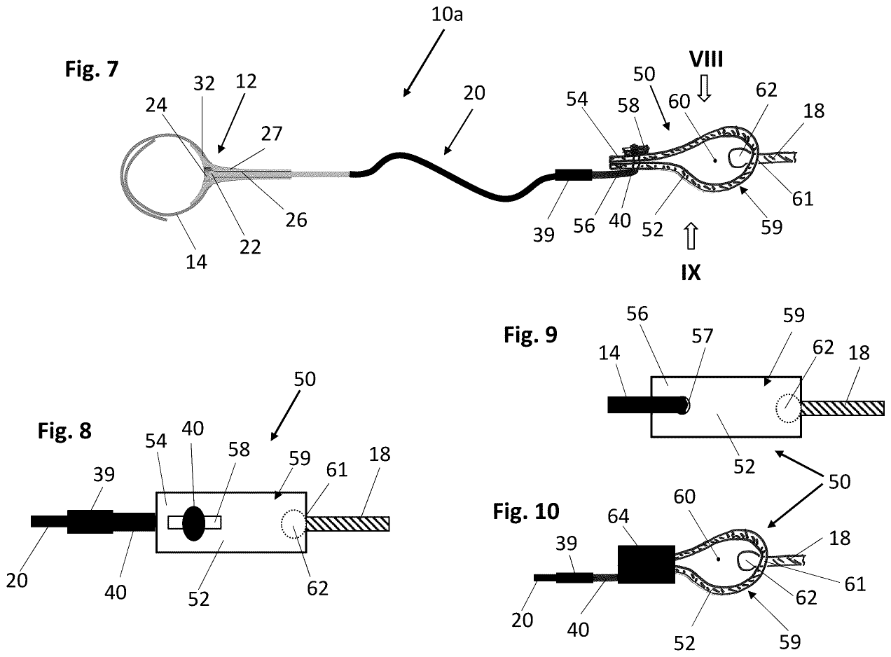

FIG. 7 shows a second embodiment 10a of the connecting assembly obtained with the invention, in which the first connector 12 and the connecting element 20, with its loop 40 on the end, are identical to the first embodiment shown in FIG. 1. The second connector 50 in this embodiment is formed by a strap 52 made of textile or plastic, the ends 54, 56 of which are connected to form a loop resulting in an accommodating area 60 for a knot 62 on the end of the leash 18. The strap 52 has a perforation 61 in the middle through which the leash 18 is inserted into the accommodating area 60.

The loop 40 on the end of the connecting element 20 passes through perforations 57 in both ends 54, 56 and is held in place in these perforations 57 in the ends 54, 56 by an elongated securing element 58. This securely connects the two ends 54, 56, even when the strap is subjected to stronger tensions.

Lastly, FIG. 10 shows a Velcro strap 64 attached to both ends 54, 56 that is wrapped around both ends 54, 56 and the loop 40 at the end of the connecting element to secure this area and the insertion of the loop in place.

In this embodiment, the end of the connecting element 20 can also be a simple end of a cord that is knotted after it has been inserted through the ends 54, 56, thus securing it in place where it passes through the perforations 57 in the ends 54, 56.

In both embodiments, the connecting element 20 can rotate freely in the first connector and the leash 18 can rotate freely in the second connector 16, 50.

The invention is not limited to the exemplary embodiments shown here, and instead can be varied within the scope of protection defined by the claims. Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure. It will be understood that certain features and subcombinations are of utility and may be employed without reference to other features and subcombinations and are contemplated within the scope of the claims.

1. A connecting assembly for connecting an object to a leash, comprising a first connector for attaching to the object, and a second connector for attaching the leash, which is connected to the first connector by a flexible connecting element such that the two connectors are spaced apart and can move in relation to one another, wherein the second connector has an accommodating area with a perforation for the leash leading into the accommodating area, and the accommodating area is large enough that it can accommodate a thickening in the leash and allows the thickening to rotate therein, and characterized in that the first connector has a bore through which the connecting element passes to allow the connecting element to rotate in the bore, wherein the second connector comprises a strap, in particular made of textile or plastic, which is folded together such that ends of the strap are connected to obtain a loop forming the accommodating area for the thickening in the leash, and in which the perforation for the leash is located.

2. The connecting assembly according to claim 1, wherein the first connector is elongated, and its bore is parallel to its longitudinal axis, wherein the bore is expanded to form a cylindrical accommodating section with a larger diameter than the bore at a first end of the first connector, wherein the accommodating section can rotatably accommodate a thickening on the connecting element.

3. The connecting assembly according to claim 2, wherein at least one elongated section of the first connector is rotationally symmetrical and the bore extends through a rotational center of this section.

4. The connecting assembly according to claim 2, wherein one end of the first connector is plate-shaped, and that the cylindrical accommodating section is formed in a middle of this plate-shaped section.

5. The connecting assembly according to claim 4, further comprising a cuff for an ankle or wrist, through which the first connector passes, wherein the plate-shaped section bears on an inner surface of this cuff.

6. The connecting assembly according to claim 2, wherein the first connector is formed by a cylindrical or conical section over most of its length.

7. The connecting assembly according to claim 2, wherein the accommodating section transitions into the bore with a rounded transition.

8. The connecting assembly according to claim 1, wherein the connecting element or a loop on its end passes through the ends of the strap, thus holding them in place.

9. The connecting assembly according to claim 1, wherein there is a strap of a hook and loop type fastener on one of the ends that can be wrapped around the two ends to hold them together.

10. (canceled)

11. The connecting assembly according to claim 1, wherein the connecting element is formed by a cord, line, or cable.

12. A connecting assembly for connecting an object to a leash, comprising a first connector for attaching to the object, and a second connector for attaching the leash, which is connected to the first connector by a flexible connecting element such that the two connectors are spaced apart and can move in relation to one another, wherein the second connector has an accommodating area with a perforation for the leash leading into the accommodating area, and the accommodating area is large enough that it can accommodate a thickening in the leash and allows the thickening to rotate therein, and characterized in that the first connector has a bore through which the connecting element passes to allow the connecting element to rotate in the bore, wherein the second connector is formed by a molded part that has a barrel-shaped or cylindrical section, in which the accommodating area for the thickening in the leash is formed, with a radial perforation that opens into it through which the leash is inserted, in which the barrel-shaped or cylindrical section has circumferential grooves on both ends, and the connecting element has a loop at an end facing the second connector that is placed in the two grooves.

13. The connecting assembly according to claim 12, wherein the first connector is elongated, and its bore is parallel to its longitudinal axis, wherein the bore is expanded to form a cylindrical accommodating section with a larger diameter than the bore at a first end of the first connector, wherein the accommodating section can rotatably accommodate a thickening on the connecting element.

14. The connecting assembly according to claim 13, wherein at least one elongated section of the first connector is rotationally symmetrical and the bore extends through a rotational center of this section.

15. The connecting assembly according to claim 13, wherein one end of the first connector is plate-shaped, and that the cylindrical accommodating section is formed in a middle of this plate-shaped section.

16. The connecting assembly according to claim 15, further comprising a cuff for an ankle or wrist, through which the first connector passes, wherein the plate-shaped section bears on an inner surface of this cuff.

17. The connecting assembly according to claim 13, wherein the first connector is formed by a cylindrical or conical section over most of its length.

18. The connecting assembly according to claim 13, wherein the accommodating section transitions into the bore with a rounded transition.

19. The connecting assembly according to claim 12, wherein a radial insertion section for the connecting element is formed in a middle of an end of the barrel-shaped or cylindrical section lying opposite the perforation, through which the connecting element or loop is inserted radially into the middle of the barrel-shaped section.

20. The connecting assembly according to claim 12, wherein the connecting element is formed by a cord, line, or cable.
